(19) United States
(12) Patent Application Publication
(10) Pub. No.: US 2004/0150208 A1
(43) Pub. Date: Aug. 5, 2004

(54) Vehicle structure having cross members overlapped by apertured rails

(76) Inventors: Brian Nathan, Livonia, MI (US); Gerald R. Thom, Livonia, MI (US); Brian A. Enck, Sterling Heights, MI (US); Rajesh Koli, Troy, MI (US); Stephen Fraczek, Flat Rock, MI (US); Rama Vallurupalli, Rochester Hills, MI (US); Ram Bhandarkar, Novi, MI (US)

Correspondence Address: DAIMLERCHRYSLER INTELLECTUAL CAPITAL CORPORATION, CIMS 483-02-19, 800 CHRYSLER DR EAST, AUBURN HILLS, MI, 48326-2757, US

(21) Appl. No.: 10/356,458

(22) Filed: Jan. 31, 2003

(51) Int. Cl. B62D 21/00

(52) U.S. Cl. 280/781

(57) ABSTRACT

A vehicle structure includes a combination of hydro-formed, generally tubular shaped rails joined by an overlapping joint to a two-piece cross member. The overlapping joint is formed between a rail aperture and the cross member. To retain the structural strength lost by removing material from the rails, a weld joint is formed about the total perimeter of contact between the rail aperture and the cross member. The cross member includes a shoulder area formed to nest within the rail aperture. The two-piece cross member assembly reduces total parts while providing a plurality of cross member geometries and the necessary tolerance flexibility at the rail connections. The cross member is formed of two generally C-shaped members having butted or overlapping mating surfaces joined by a perimeter weld joint.

### FIELD OF THE INVENTION

The present invention relates in general to vehicle frames and more specifically to a joint for and method of joining vehicle structural frames.

### BACKGROUND OF THE INVENTION

A structural frame for vehicles typically includes beams as well as tubular members. Where sections of the structure connect and/or cross, space requirements often require that portions of one or both of the members be removed. To replace the structural strength lost by material removal, additional structure including mechanical fasteners, weld joints, and braces or brackets are often added. By increasing the number of component parts of a vehicle frame, the cost, time of construction, and complexity of the frame increase.

Many common vehicle frames include a combination of tubular-shaped members. These tubular-shaped members are commonly manufactured using a hydro-forming process and are often used as longitudinal rails. This permits frame sections to be manufactured from single rail parts. The tubular shape increases the mechanical strength of the member. Where complex geometries are required, including cross member sections, multiple part assemblies are commonly used. These multiple part assemblies commonly use C-shaped members which are joined and reinforced by additional structural members. Disadvantages of this cross member design include the cost and complexity of manufacturing multi-part items and additional structure often required to join these multi-part cross member assemblies to the tubular rails.

It is therefore desirable to provide a vehicle frame assembly which reduces the amount of component parts, retains the full structural strength of the hydro-formed tubular members at cross member intersections, and reduces the complexity of joining the cross members to the front to back running tubular rails.

### SUMMARY OF THE INVENTION

According to the present invention, a vehicle structure includes at least one cross-member having at least one mating shoulder formed thereon. At least one rail having at least one receiving aperture is sized to slidably mate with the mating shoulder. An overlapping joint is formed when the receiving aperture is slidably mated to the mating shoulder. A weld joint is then formed at the overlapping joint to join the rail to the cross-member.

To retain the structural strength lost by removing the aperture from the rails, the weld joint is formed about the total perimeter at the contact point between the rail aperture and the cross member. A two-piece cross member assembly is used to reduce the total number of parts required for the cross member while retaining the capability of forming the cross member in a plurality of shapes and having the necessary dimensional flexibility for mounting the various vehicle components on the cross members. The two piece cross member is formed of two generally C-shaped members having butted or overlapped mating surfaces. A perimeter weld joint is formed at the mating surfaces to join the two piece assembly into a cross member.

In one example of the invention, the cross member includes a shoulder area formed adjacent to the attachment point with the aperture in the rail. The shoulder is preferably rounded to provide a seating surface for the rail aperture. The rounded shoulder also provides flexibility in locating the cross member-to-rail joint to permit the vehicle frame to meet vehicle frame construction tolerances. The aperture in the rail is similarly dimensioned to permit flexible construction tolerances during vehicle frame assembly. The rail having the aperture is slidably disposed over the cross member and the weld joint is made to join the two members. In an alternate embodiment, the cross member is positioned above the rail and a similar perimeter weld joint is formed.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a vehicle frame incorporating the overlapping joints of the present invention;

FIG. 2 is a perspective view of a partial assembly having a first rail adjacent to a cross member showing the receiving aperture and shoulder of the present invention prior to joining the first rail to the cross member;

FIG. 3 is the partial assembly drawing of FIG. 2 showing the first rail in its mated position with the cross member and a welded overlapping joint of the present invention;

FIG. 4 is a perspective view showing an installed first rail and a second rail prior to assembly onto the cross member;

FIG. 5 is an elevation view of a two-piece cross member assembly of the present invention following assembly of the two pieces;

FIG. 6 is an exploded assembly drawing of the two piece cross member of the present invention prior to assembly; and

FIG. 7 is a flow diagram for the steps to form and join the component parts of a vehicle structure of the present invention.

### DETAILED DESCRIPTION OF THE PREFERRED EMBODIMENTS

The following description is merely exemplary in nature and is in no way intended to limit the invention, its application, or uses.

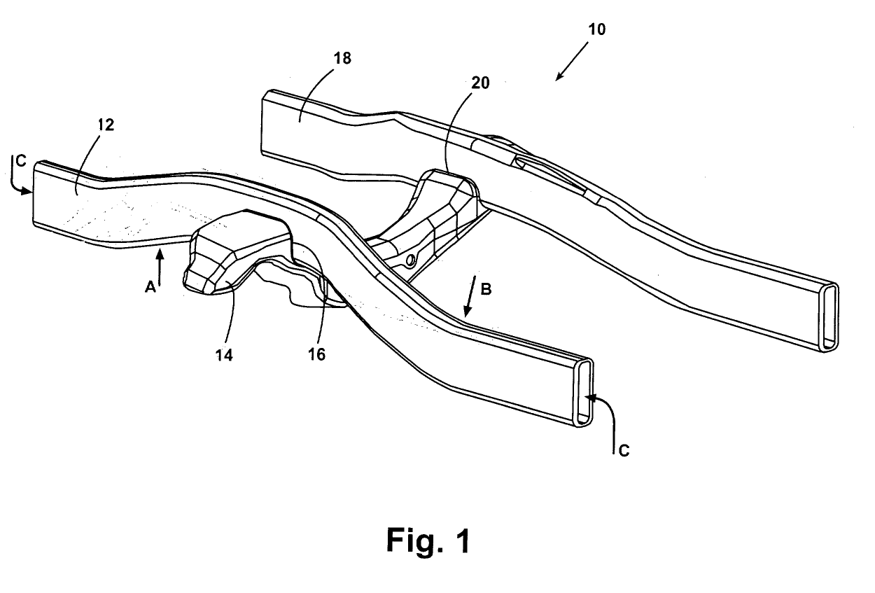

Referring to FIG. 1, a preferred embodiment of the present invention is shown. A portion of a vehicle frame 10 includes a first rail 12 overlapped and joined to a cross member 14 at a first overlapping joint 16. A second rail 18 is similarly overlapped and joined to the cross member 14 at a second overlapping joint 20. Both the first rail 12 and the second rail 18 are shown as generally tubular-shaped, hydro-formed members. As commonly configured, the first rail 12 and the second rail 18 include one or more bends identified by arrows A and B, respectively. Also as commonly known, each of the first rail 12 and the second rail 18 have open ends C required for the hydro-forming process.

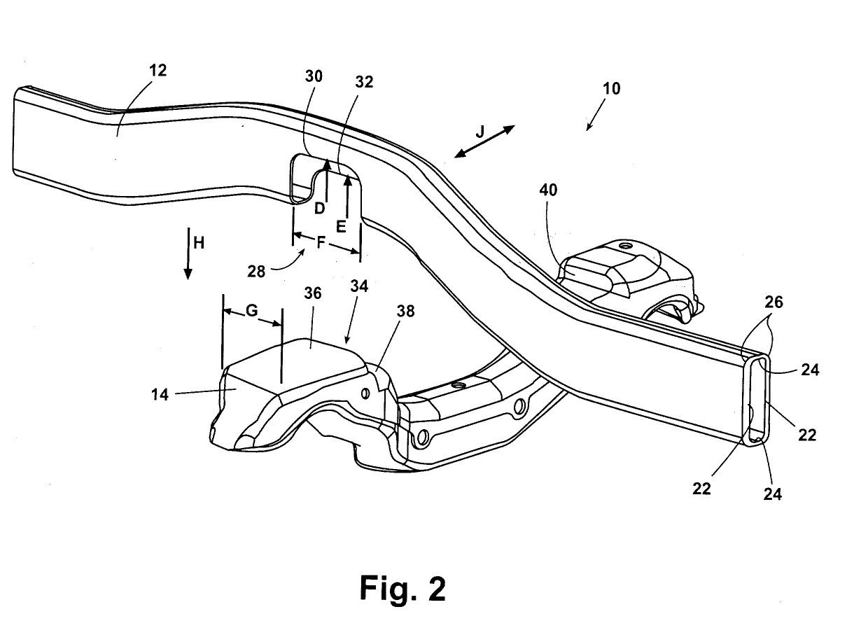

Referring to FIG. 2, two components of the vehicle frame 10 are shown. The first rail 12 is shown prior to engagement with the cross member 14. The first rail 12 is preferably a hydroformed single piece tube having integral side rails 22, a pair of end plates 24, and eased corners 26. Each of the side rails 22, the end plates 24 and the eased corners 26 form a contiguous perimeter for the first rail 12. The eased corners 26 are generally formed as radii to reduce corner stresses in the rails. The first rail 12 can also be formed of two or more parts wherein any two or more of the integral side rails 22, the end plates 24 or the eased corners 26 are individual parts requiring assembly/joining to form the first rail 12. A first rail aperture 28 is formed in the first rail 12 by one of a plurality of known processes. These processes can include cutting, burning, stamping, etc. The first rail aperture 28 includes an outer C-shaped curve 30 and an inner C-shaped curve 32, respectively. In the embodiment shown, the outer C-shaped curve 30 has a height D and the inner C-shaped curve 32 has a height E.

The cross member 14 includes a first shoulder 34 having an upper land 36 and a lower land 38. A second shoulder 40 is also disposed on an opposite end of the cross member 14. The purpose of the first shoulder 34 and the second shoulder 40 are to receive each of the first rail 12 and the second rail 18, respectively. In the embodiment shown, the upper land 36 and the lower land 38 are displaced vertically from each other. One skilled in the art will recognize that the present invention is not limited to the configuration shown for the first shoulder 34 and the second shoulder 40. Multiple variations of the shoulders are possible to suit the required geometry of the vehicle frame 10.

In the embodiment shown, the height D of the outer C-shaped curve 30 and the height E of the inner C-shaped curve 32 are adjusted to suit the elevation of the upper land 36 and the lower land 38 respectively. An aperture width F is also shown. The aperture width F is similarly adjustable to suit a cross member width G. Both the height D and the height E for the first rail aperture 28 are also adjustable depending upon the required total standoff when the first rail 12 is connected to the cross member 14. The first rail 12 is joined to the cross member 14 by overlapping the first rail aperture 28 over the first shoulder 34. The first rail 12 is joined to the cross member 14 in an assembly direction H. Dimensional tolerances are allowed by the aperture width F, the height D and the height E such that the rails when joined to the cross member 14 are provided with an adjustment direction J permitting the vehicle frame 10 to meet construction tolerances.

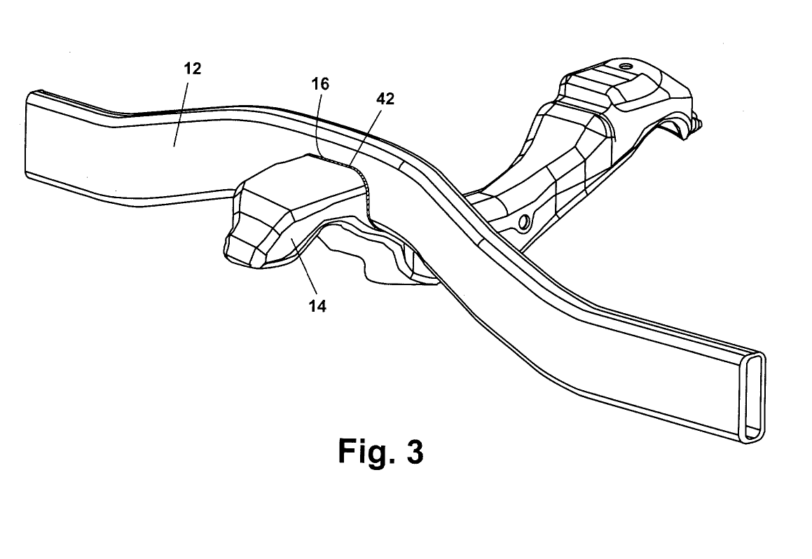

Referring to FIG. 3, the first rail 12 is shown overlapped with the cross member 14 forming the first overlapping joint 16. A weld joint 42 is formed about a complete perimeter of the first rail aperture 28. The weld joint 42 (only partially shown in FIG. 3) can be made using a variety of welding processes, including metal inert gas (MIG), tungsten inert gas (TIG), laser welding, stick welding, etc. The weld joint 42 permits the cross member 14 to structurally reinforce the first rail 12 for the material removed in the first rail aperture 28 (shown in FIG. 2).

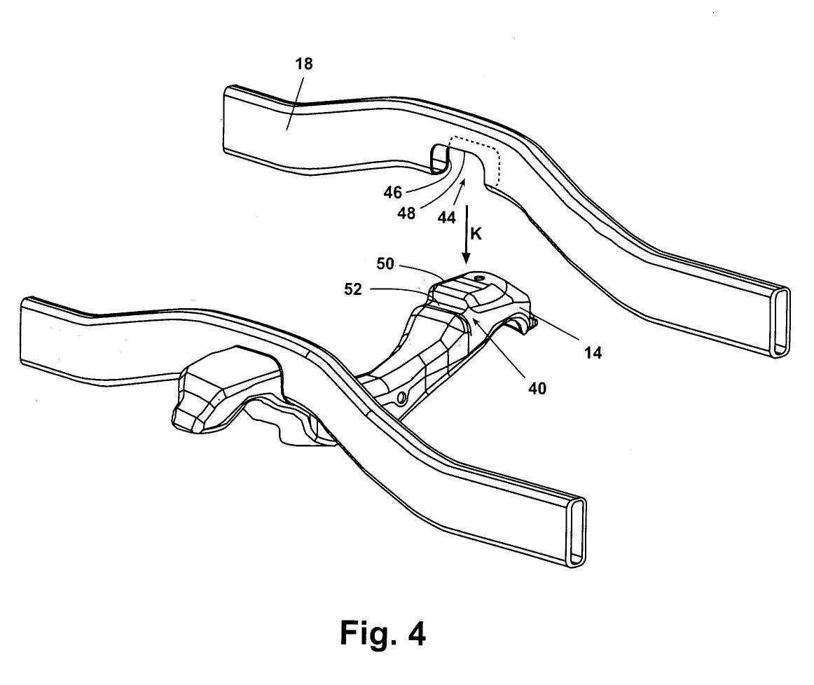

Referring now to FIG. 4, the second rail 18 is shown prior to assembly with the cross member 14. The second rail 18 is formed similar to the first rail 12 and includes a second rail aperture 44. The second rail aperture 44 includes an outer C-shaped curve 46 and an inner C-shaped curve 48 similar to curves provided for the first rail aperture 28. The cross member 14 includes the second shoulder 40 having an upper land 50 and a lower land 52. As previously discussed, the second rail 18 is joined to the cross member 14 in an assembly direction K. Following assembly, the second overlapping joint 20 (shown in FIG. 1) is connected by a weld joint (not shown) similar to the weld joint 42.

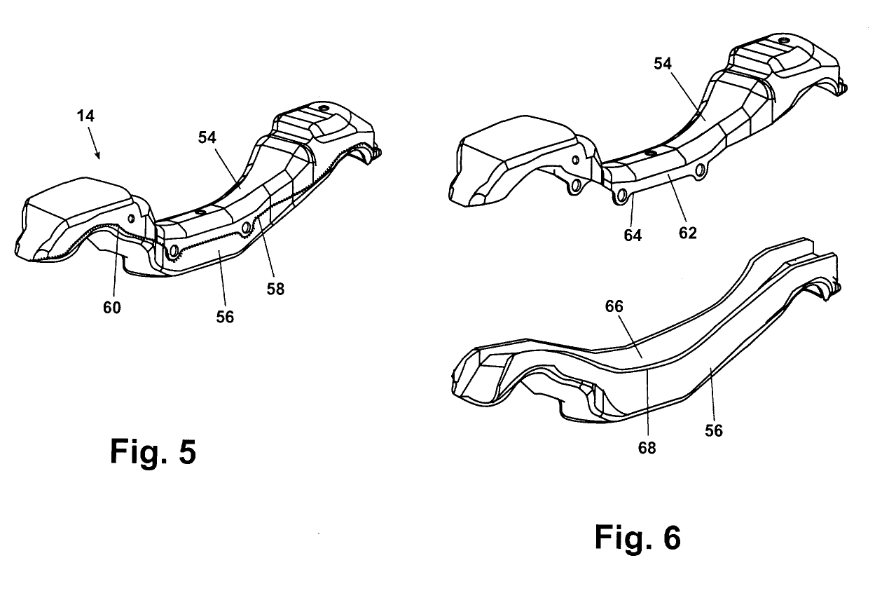

Referring to FIG. 5, the cross member 14 includes a cross member upper section 54 and a cross member lower section 56 connectably joined at a mating joint 58. A weld joint 60 (shown in partial length only for clarity) connectably joins the cross member upper section 54 to the cross member lower section 56 along the mating joint 58. Weld joint 60 can be either a continuous or a non-continuous weld joint for the full perimeter of mating joint 58, based on the structural requirements of the final assembly.

Referring to FIG. 6, the cross member 14 is shown prior to assembly of its two component parts. The cross member upper section 54 includes a perimeter wall 62 and a first mating edge 64. The cross member lower section 56 includes a perimeter wall 66 and a second mating edge 68. The first mating edge 64 and the second mating edge 68 are joined to form the mating joint 58 (shown in FIG. 5). The mating joint 58 can be formed by overlapping the first mating edge 64 with the second mating edge 68 or by butting these two mating edges.

Both the cross member upper section 54 and the cross member lower section 56 of the cross member 14 are generally formed by drawing or stamping a metal plate. The advantage of using a single plate to form each of the cross member upper section 54 and the cross member lower section 56 is the overall reduction in parts requiring assembly to form the cross member 14. Only a single weld joint, i.e., the weld joint 60 shown in FIG. 5, is required to form the cross member 14.

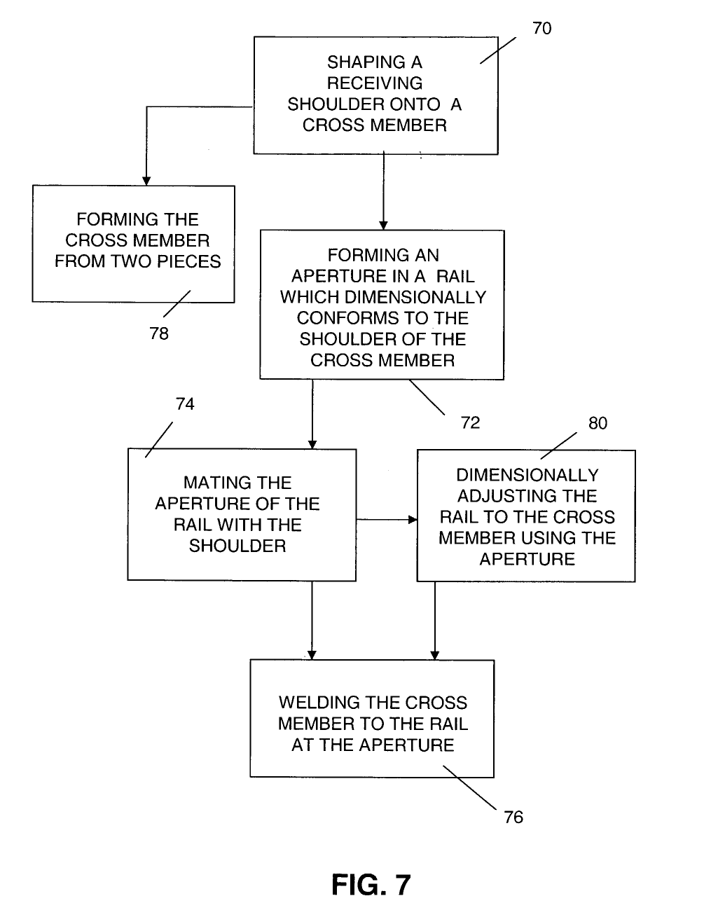

Referring to FIG. 7, the method to form an overlapping joint according to the present invention is detailed. In a step 70, a shoulder (34, 40) is formed onto a cross member 14. The shoulder (34, 40) can have one or more lands (36, 38, 50, 52). In a forming step 72, an aperture (28, 44) is formed in a rail (12, 18). The aperture (28, 44) is formed based on the geometry of the shoulder (34, 40) such that a dimensional adjustment between the rail (12, 18) and the cross member 14 is possible. In a mating step 74, the aperture (28, 44) of the rail (12, 18) is mated (e.g., overlapped) with the shoulder (34, 40) of the cross member 14. In a welding step 76, a weld joint 42 is formed about the perimeter of the aperture (28, 44) where the aperture (28, 44) mates with the shoulder (34, 40) of the cross member 14, thereby joining the rail (12, 18) to the cross member 14. In a parallel construction step 78, the cross member 14 is formed by joining two pieces (54, 56) with a perimeter weld joint 60. In a parallel adjustment step 80, the rail (12, 18) is dimensionally-adjusted as necessary, relative to the cross member 14, to meet a vehicle frame 10 construction tolerance.

A vehicle frame 10 of the present invention offers several advantages. By forming an aperture in longitudinal rails of a vehicle frame, and overlapping the rails at the aperture to cross members of the vehicle frame, structural rigidity and strength are retained in an assembly which requires a limited number of component parts. Hydro-formed rails can be used as known in the art without the requirement for additional bracing or flanges following assembly of the rails to a cross member. By using a two-piece cross member assembly, multiple component parts previously known for cross member assemblies are reduced and the overall assembly provides structural rigidity and strength at a lower cost and with simpler assembly. The capability of adjusting the aperture size provided in the longitudinal rails provides assembly latitude such that construction tolerances for the overall vehicle frame can be met. A vehicle frame according to principles of the present invention also provides a totally welded vehicle frame assembly thereby reducing the number of component parts and eliminating the need for mechanical fasteners or additional brackets to form the frame assembly.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A vehicle structure comprising:
at least one cross-member having at least one mating shoulder formed thereon;
at least one rail having at least one receiving aperture sized to slidably mate with said mating shoulder;
an overlapping joint formed with said receiving aperture slidably mated at said mating shoulder; and
a weld joint formed at said overlapping joint to join said rail to said cross-member.

2. The structure of claim 1, wherein said rail further comprises a generally tubular body.

3. The structure of claim 2, wherein said tubular body further comprises a hydro-formed single part.

4. The structure of claim 1, wherein said weld joint further comprises a fillet weld circumferentially formed about an entire perimeter of said receiving aperture.

5. The structure of claim 1, wherein said at least one rail forms an upper overlapping joint above said at least one cross-member.

6. The structure of claim 1, wherein said at least one cross-member forms an upper overlapping joint above said at least one rail.

7. The structure of claim 1, wherein said at least one rail further comprises a pair of generally parallel longitudinal members of said vehicle structure.

8. The structure of claim 7, wherein said cross-member further comprises a linking member of said vehicle structure approximately perpendicularly aligned between said longitudinal members.

9. An overlapped structural portion of a vehicle frame comprising:
a cross-member having a shoulder formed thereon;
a generally tubular rail having a receiving aperture sized to slidably mate with said shoulder;
said cross member formed as a two-piece body including an upper part joined to a lower part;
an overlapping joint formed with said receiving aperture slidably mated to said shoulder; and
a weld joint formed at said overlapping joint to join said rail to said cross-member.

10. The vehicle frame of claim 9, further comprising:
a first piece of said two-piece body having said shoulder formed on an outer surface thereof and a perimeter wall extending from perimeter edges of said outer surface; and
a first mating edge circumferentially formed about a distal end of said wall.

11. The vehicle frame of claim 10, further comprising:
a second piece of said two-piece body having a generally C-shaped outer perimeter and a second mating edge; and
a body weld joint joining the first piece to the second piece with said second mating edge aligned with said first mating edge.

12. The vehicle frame of claim 9, wherein said receiving aperture further comprises a pair of generally C-shaped apertures each formed in opposed walls of said tubular rail.

13. The vehicle frame of claim 12, wherein each C-shaped aperture further comprises an aperture height selected to match a mating geometry of said shoulder.

14. The vehicle frame of claim 9, wherein said tubular rail further comprises a hydro-formed single part having a generally rectangular shape with eased corners.

15. A method to join vehicle frame components comprising the steps of:
shaping a receiving shoulder onto a cross-member;
forming an aperture dimensionally conforming to said receiving shoulder in a tubular rail;
mating said cross-member with said tubular rail at said aperture; and
welding said cross-member to said tubular rail at said receiving shoulder.

16. The method of claim 15, comprising constructing said cross-member as a two-piece body.

17. The method of claim 15, comprising dimensionally adjusting said aperture to permit location of said tubular rail relative to said cross-member within a frame construction tolerance.
